(19) United States
(12) Patent Application Publication
(10) Pub. No.: US 2026/0093595 A1
(43) Pub. Date: Apr. 2, 2026

(54) LANGUAGE MODEL RESPONSE EVALUATION AND ENHANCEMENT

(71) Applicant: Expression Networks LLC, Washington, DC (US)

(72) Inventors: Abir Ray, Washington, DC (US); Lei Yu, Washington, DC (US)

(21) Appl. No.: 19/347,348

(22) Filed: Oct. 1, 2025

Related U.S. Application Data
(60) Provisional application No. 63/701,724, filed on Oct. 1, 2024.
(60) Provisional application No. 63/701,683, filed on Oct. 1, 2024.

(51) Int. Cl. G06F 11/34; G06F 16/34

(52) U.S. Cl. CPC G06F 11/3414; G06F 16/345

(57) ABSTRACT

The present disclosure generally relates to evaluating and enhancing LLM responses. In some implementations, a system includes multiple language models with different specialized roles that work together to improve response reliability and transparency. A responder model can generate initial responses to user queries, providing diverse perspectives on the same input. An evaluator model can assess and combines responses from the responder models into an accurate and reliable output. A reporter model can generate summaries and alerts about response quality and confidence levels, providing transparency to users about the decision-making process. An artificial intelligence (AI) engine can manage the flow of information between the different models, orchestrating their interactions and ensuring proper sequencing of operations. A retrieval system can provide additional context from external knowledge sources, allowing the system to generate accurate and well-informed responses.

### CROSS-REFERENCE TO RELATED APPLICATIONS

This application claims the benefit of U.S. Provisional Patent Application No. 63/701,683, filed October 1, 2024, and U.S. Provisional Patent Application No. 63/701,724, filed October 1, 2024, both of which are incorporated herein by reference in their entirety.

### TECHNICAL FIELD

The present disclosure relates to large language model (LLM) systems, and more specifically to evaluating and enhancing the reliability, consistency, and transparency of LLM responses.

### BACKGROUND

LLMs are capable of generating human-like responses across a wide range of applications, from answering questions and writing documents to translating languages and generating code. These models are trained on vast datasets and can process natural language inputs to produce contextually relevant outputs. However, LLMs occasionally provide responses that are unreliable or inaccurate, a phenomenon that is known as hallucination.

### SUMMARY

This disclosure describes techniques for improving the reliability and transparency of LLM responses through ensemble learning and multi-stage model coordination. The present disclosure addresses challenges with language model accuracy, consistency, and explainability by using specialized models to generate, evaluate, and verify response outputs.

Some aspects relate to a system that includes multiple LLMs configured to process user queries in different stages. The system has responder models that generate initial responses to user questions, an evaluator model that assesses and combines responses from the responder models, and a reporter model that creates summaries and alerts about the quality and confidence of the responses. The system also includes a coordination engine that manages the flow of information between the different models and a retrieval system that provides additional context from external knowledge sources.

The described techniques can be applied to various applications, such as converting natural language questions into database queries, generating and analyzing documents, and creating visualizations like maps and network diagrams. For example, in law enforcement applications, an agent can ask questions about phone records, and the system can generate the appropriate database queries, retrieve the requested information, and presents results in formats like tables, network diagrams, or geographic maps.

Some aspects of the present disclosure relate to evaluating model maturity across different capability levels, from basic text-to-query functions to advanced domain-specific applications. The system can measure performance in terms of accuracy, consistency, and transparency, with specific thresholds and criteria for each maturity level.

The framework described herein provides greater transparency with explanations of how responses were generated, confidence scores indicating the reliability of responses, and logging capabilities that allow users to trace the decision-making process. An adversarial model component can be used to test and strengthen other models (such as the evaluator model) against potential attacks or manipulation.

One aspect of the present disclosure relates to a method including: receiving a user input including a prompt and a query; obtaining contextual information from one or more data sources based on the query; providing the prompt, the query, and the contextual information to a set of responder language models; receiving a set of responses from the set of responder language models; outputting the prompt and the set of responses to an evaluator language model that is configured to perform an assessment of the set of responses; receiving the assessment and one or more aggregate responses from the evaluator language model; providing the prompt and at least one of the assessment or the query to a reporter language model that is configured to generate an alert or summary of the one or more aggregate responses; receiving the summary or alert from the reporter language model; and outputting the one or more aggregate responses and the summary or alert for display on a user interface.

In some implementations, the evaluator language model is trained using a generative adversarial network (GAN) framework in which the evaluator language model iteratively competes with an adversary language model that is configured to provide inconsistent or incorrect data to the evaluator language model.

In some implementations, the assessment indicates at least one of: a confidence score indicating a degree of similarity between the set of responses received from the set of responder language models; one or more inconsistencies between the set of responses received from the set of responder language models; or a quality metric indicating an accuracy of the set of responses.

In some implementations, the evaluator language model is configured to combine information from the set of responses into the one or more aggregate responses.

In some implementations, the summary or alert includes at least one of: an explanation of how the one or more aggregate responses were generated from the set of responses; a confidence level associated with the one or more aggregate responses; or an indication of possible inconsistencies in the one or more aggregate responses.

In some implementations, the reporter language model is configured to monitor and report performance metrics for the set of responder language models, the evaluator language model, and the reporter language model.

In some implementations, the method further includes: receiving, via the user interface, feedback regarding the one or more aggregate responses; and adjusting parameters of at least one of the evaluator language model, the reporter language model, or the set of responder language models based on the feedback.

In some implementations, the one or more aggregate responses include at least one of: a heat map including a visualization of geographic intensity patterns; an interactive network diagram indicating relationships between a set of entities; structured tabular data; a database query command; or an interactive map that indicates respective locations of the set of entities.

In some implementations, the method further includes: identifying one or more pending changes to a first document based on previous changes to a second document; receiving, via the user interface, a request to confirm or cancel the pending changes to the first document; and applying the pending changes to the first document in accordance with the request.

In some implementations, obtaining contextual information includes: performing a semantic search within a vector database to one or more document embeddings; and providing the one or more document embeddings to the set of responder language models with the query and the prompt.

In some implementations, the method further includes: determining a maturity level of each responder language model based on at least one of an accuracy metric, a consistency metric, or a transparency metric associated with the responder language model; and selecting a subset of the set of responder language models to process the query based on the determined maturity level.

In some implementations, the accuracy metric includes a percentage of correct responses generated by the responder language model, the consistency metric includes a stability score indicating variability in responses provided by the responder language model, and the transparency metric indicates a traceability of responses provided by the responder language model.

In some implementations, the one or more data sources include repositories of domain-specific information, the repositories including at least one of: legal databases including case law and regulatory documents; medical databases including patient records and clinical guidelines; law enforcement databases including criminal records and investigative data; or government databases including policy documents and procedural guidelines.

In some implementations, obtaining the contextual information includes: identifying a domain associated with the query; selecting one or more repositories from the repositories of domain-specific information that are associated with the identified domain; and retrieving the contextual information from the selected repositories.

Another aspect of the present disclosure relates to a system including: one or more processors; and memory storing instructions that, when executed by the one or more processors, cause the system to perform any of the foregoing operations.

Another aspect of the present disclosure relates to a non-transitory computer-readable medium storing instructions that, when executed by one or more processors, cause the one or more processors to perform any of the foregoing operations.

The details of one or more embodiments are set forth in the accompanying drawings and the description below. Other features, objects, and advantages of these systems and methods will be apparent from the description and drawings, and from the claims.

### BRIEF DESCRIPTION OF FIGURES

FIGS. 1 and 2 are diagrams of an example computing system that supports LLM evaluation and enhancement, according to some implementations.

FIGS. 3-9 illustrate example interactions between a user and an AI engine of the system depicted in FIGS. 1 and 2.

FIG. 10 is a flowchart of an example method for LLM evaluation and enhancement, according to some implementations.

### DETAILED DESCRIPTION

Some aspects of the present disclosure relate to an LLM maturity model framework that evaluates and categorizes language models across multiple dimensions to determine their readiness for specific applications. The maturity model framework can assess LLMs based on three primary categories: accuracy/efficacy, consistency/robustness, and transparency/traceability. In some implementations, the accuracy/efficacy category measures the capability of an LLM to produce correct queries across different complexity levels, from basic text-to-query functions handling simple user questions to advanced domain-specific applications that demonstrate expert-level understanding of specialized terminologies and databases. The consistency/robustness category may evaluate the ability of an LLM to produce stable and consistent results under variations of user questions, prompt engineering, and linguistic differences, ensuring reliable performance across different input conditions. The transparency/traceability category can assess the capability of an LLM to provide explanations, reasoning, and documentation of decision-making processes, supporting interpretability and observability requirements.

The maturity model framework described herein includes four progressive maturity levels for each category, with specific acceptance criteria and performance thresholds that determine the classification of an LLM within the framework. In some implementations, the maturity model framework can be used to automatically evaluate and select appropriate LLMs from the LLM endpoint 108 based on specific user queries or application domains. The evaluator LLM 204 can use maturity model criteria to assess the performance and suitability of responses generated by the responder LLMs 202, ensuring that selected models meet all reliability and transparency standards for the intended use case. The framework described herein can support deployment decisions by providing objective measures of LLM readiness across different application areas, such as law enforcement, medicine, legal advocacy, government, and scientific research, allowing the system to match model capabilities with domain-specific requirements and performance expectations.

The framework described herein offers a comprehensive approach to enhancing the trustworthiness, reliability, and transparency of LLM operations through coordinated ensemble learning and multi-stage model validation. The described framework addresses challenges in LLM deployments by using multiple specialized language models in combination to reduce hallucinations, improve response consistency, and provide clear explanations of decision-making processes. The described framework involves response generation, evaluation, reporting, and adversarial testing to create a robust system that can identify potential errors, assess confidence levels, and maintain accountability throughout the query processing workflow. The framework leverages automated monitoring capabilities to track model performance metrics, log decision processes, and generate alerts when responses fall below established reliability thresholds. The framework enables organizations to deploy LLM-powered applications with greater confidence by providing mechanisms for human oversight, audit trails, and continuous quality assessment that support regulatory compliance and operational governance requirements across various application domains.

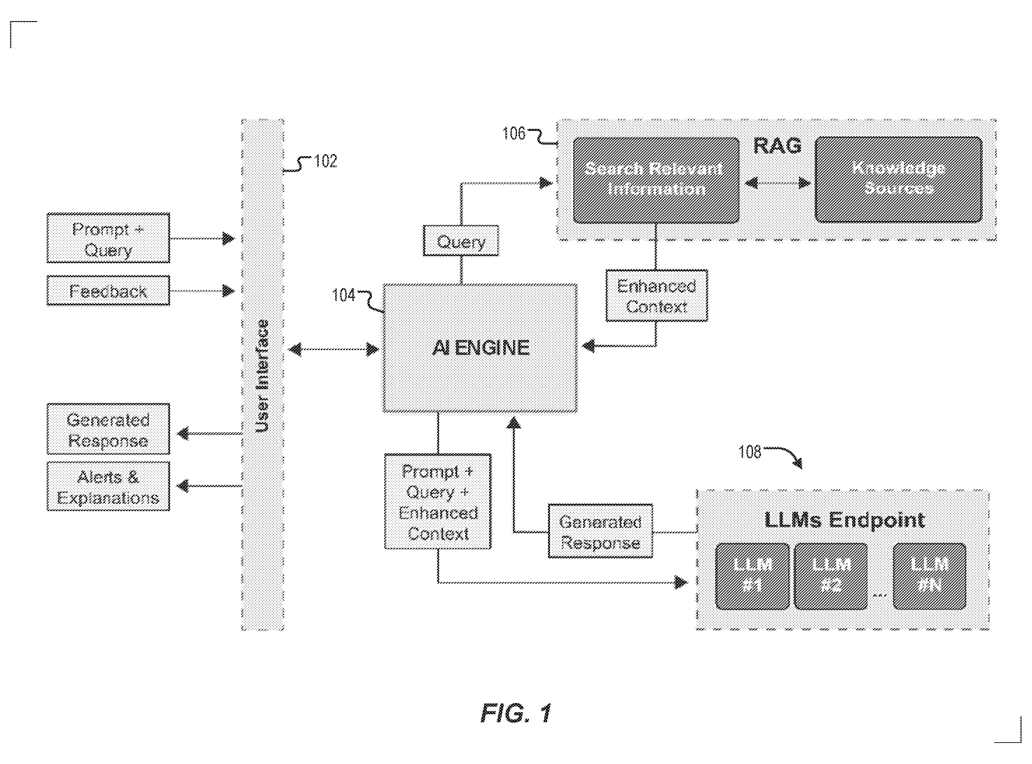

FIG. 1 is a diagram of an example computing system that supports LLM evaluation and enhancement, according to some implementations. The computing system of FIG. 1 includes multiple interconnected components that work together to process user inputs and generate responses. As shown in FIG. 1, the system includes a user interface 102 that serves as the primary interaction point for receiving user inputs such as prompts and queries, and for providing feedback to users. The computing system 200 also includes an AI engine 104 that communicates with the user interface 102 and coordinates interactions between various system elements.

The system further includes a retrieval-augmented generation (RAG) module 106 that communicates with the AI engine 104 to provide enhanced context information for processing user queries. The RAG module 106 may partition information into separate repositories that include sample documents for acquisition processes and prompts for common user questions. In some cases, the RAG module 106 searches through relevant information and knowledge sources to enhance the context of queries processed by the AI engine 104. The enhanced context may improve the accuracy and relevance of responses generated by the system. The RAG module 106 can maintain vector databases that contain relevant documents. In some implementations, the RAG module 106 conducts semantic searches to retrieve contextually appropriate information based on user inputs.

The AI engine 104 may communicate with an LLM endpoint 108 that includes multiple LLM instances, including LLM 1, LLM 2, ... LLM N. The LLM endpoint 108 may receive prompts, queries, and enhanced context from the AI engine 104 and generate responses that are sent back to the AI engine 104. In some cases, the AI engine 104 selects a particular LLM to use based on attributes of the user query or the type of processing involved. The AI engine 104 can process responses received from the LLM endpoint 108 and provide generated responses along with alerts and explanations through the user interface 102.

The system of FIG. 1 can implement a modular open system approach (MOSA) that uses Docker containers for maximum portability and scalability. This modular architecture allows individual components to be updated, replaced, or scaled independently without affecting the operation of other system elements. Docker containerization allows the system to be deployed across different computing environments, and enables horizontal scaling by adding additional container instances as processing demands increase. The system may be configured for different application domains, such as law enforcement, medicine, legal advocacy, government, and scientific research by modifying the configuration of the RAG module 106, adjusting the selection of models in the LLM endpoint 108, and/or configuring the user interface 102 to meet domain-specific requirements.

The system of FIG. 1 can be implemented using various hardware components that support LLM processing and user interaction. In some implementations, the user interface 102 can be accessed through a client device such as a laptop, tablet, desktop computer, smartphone, or other computing device equipped with a display screen and/or input mechanism. The client device may include one or more processors, such as central processing units (CPUs), graphics processing units (GPUs), or specialized processing units capable of rendering the user interface 102 and communicating with the AI engine 104 through network connections. The client device can include memory components, storage systems, and network interfaces that facilitate data transmission and user interaction with the system.

The AI engine 104, RAG module 106, and LLM endpoint 108 can be deployed on server infrastructure that includes high-performance computing resources capable of handling the computational demands of language model processing. In some examples, the server infrastructure includes multiple processors, such as multi-core CPUs, tensor processing units (TPUs), or GPU clusters that provide parallel processing capabilities for running multiple LLMs simultaneously. The servers may include substantial memory resources, such as random access memory (RAM) and high-speed storage systems, to support the loading and execution of large language models and the storage of vector databases maintained by the RAG module 106. The system can be distributed across multiple physical servers or cloud computing instances, with load balancing mechanisms that distribute processing tasks across available hardware resources to maintain performance and reliability as user demand fluctuates.

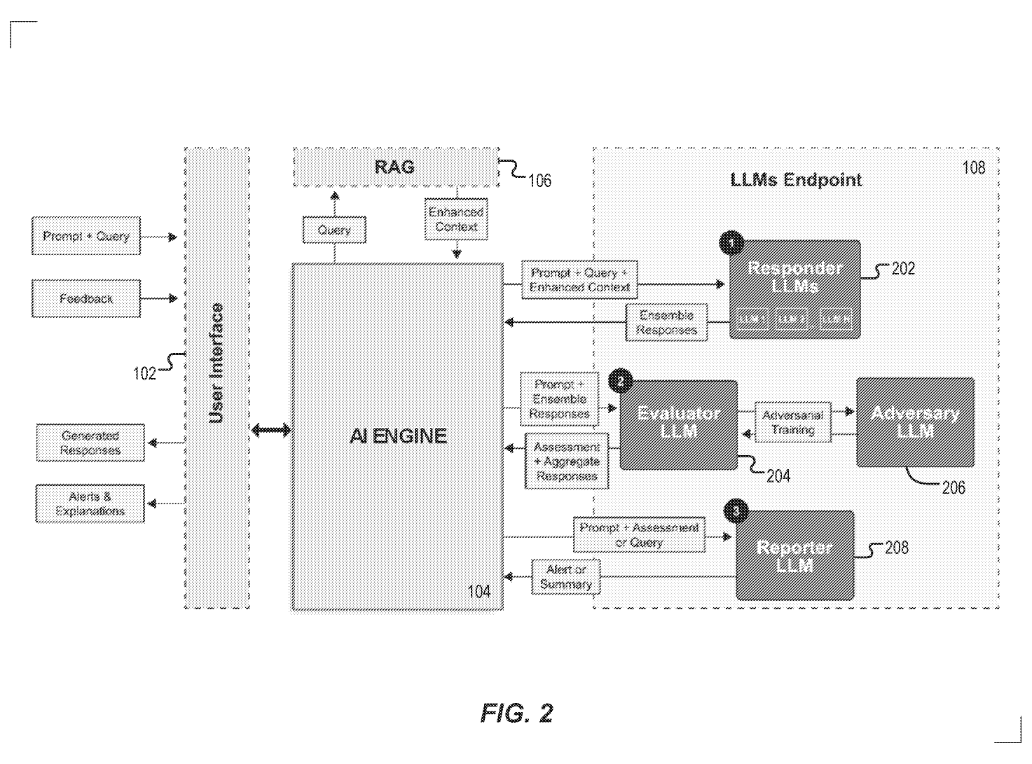

FIG. 2 is another diagram of the computing system depicted in FIG. 1. Specifically, FIG. 2 illustrates a more detailed view of the system that supports ensemble learning through multiple specialized language models. As shown in FIG. 2, the system includes responder LLMs 202 that process queries and generate initial responses to user inputs. The responder LLMs 202 can operate in parallel to provide multiple perspectives on the same query, with each model potentially offering different approaches or insights based on the training and configuration of the model. In some cases, the responder LLMs 202 receive enhanced prompts and queries from the AI engine 104 that have been augmented with contextual information from the RAG module 106. The AI engine 104 may select one or more responder LLMs 202 from the available models to create an ensemble that collectively addresses the user's query with greater reliability than a single model could provide.

The system includes an evaluator LLM 204 that receives ensemble responses from the responder LLMs 202 and performs assessment functions to determine the quality and consistency of the generated responses. The evaluator LLM 204 can assess confidence levels by measuring agreement among the ensemble responses from the multiple responder LLMs 202, where higher agreement between responses indicates greater confidence in the generated output. In some cases, the evaluator LLM 204 compares responses from different responder LLMs 202 to identify inconsistencies, potential hallucinations, or areas where the models disagree. The evaluator LLM 204 may generate assessment data that includes confidence scores, quality metrics, and recommendations for how to aggregate or present the ensemble responses to the user. The evaluation process may involve analyzing both the content and the reasoning provided by each of the responder LLMs 202 to determine which responses are the most reliable or accurate.

As shown in FIG. 2, the system includes an adversary LLM 206 that provides adversarial training input to strengthen the overall system against potential attacks or manipulation. The adversary LLM 206 may generate poisoned data or manipulated prompts that are designed to test and strengthen the other LLMs against adversarial attacks. In some cases, the adversary LLM 206 creates challenging scenarios or edge cases that help identify weaknesses in the responder LLMs 202 or the evaluator LLM 204. The adversarial training process may occur offline from the main LLM-augmented workflows, allowing the system to improve robustness without affecting real-time user interactions. The adversary LLM 206 can work in conjunction with the evaluator LLM 204 in a generative adversarial network framework, where the two models iteratively compete against each other to improve the quality of the output.

The system also includes a reporter LLM 208 that receives assessment data from the evaluator LLM 204 and generates summaries and/or alerts in user-desired detail and format based on the evaluation results. The reporter LLM 208 may process the assessment data to create user-friendly reports that explain the confidence levels, highlight areas of agreement or disagreement among the responder LLMs 202, and provide transparency about the decision-making process. In some cases, the reporter LLM 208 generates different types of outputs depending on the user's preferences and the context of the query, ranging from brief summaries to detailed explanations of how the ensemble reached specific conclusions. The reporter LLM 208 can implement both passive observability, e.g., through logging of model statistics and explanations, and active alert mechanisms for high-priority events such as detected hallucinations or low confidence responses. The AI engine 104 may coordinate the flow of information between the constituent LLMs of the system, using an ensemble learning approach where multiple models with different roles work together to provide more reliable and transparent responses than any one model could provide independently.

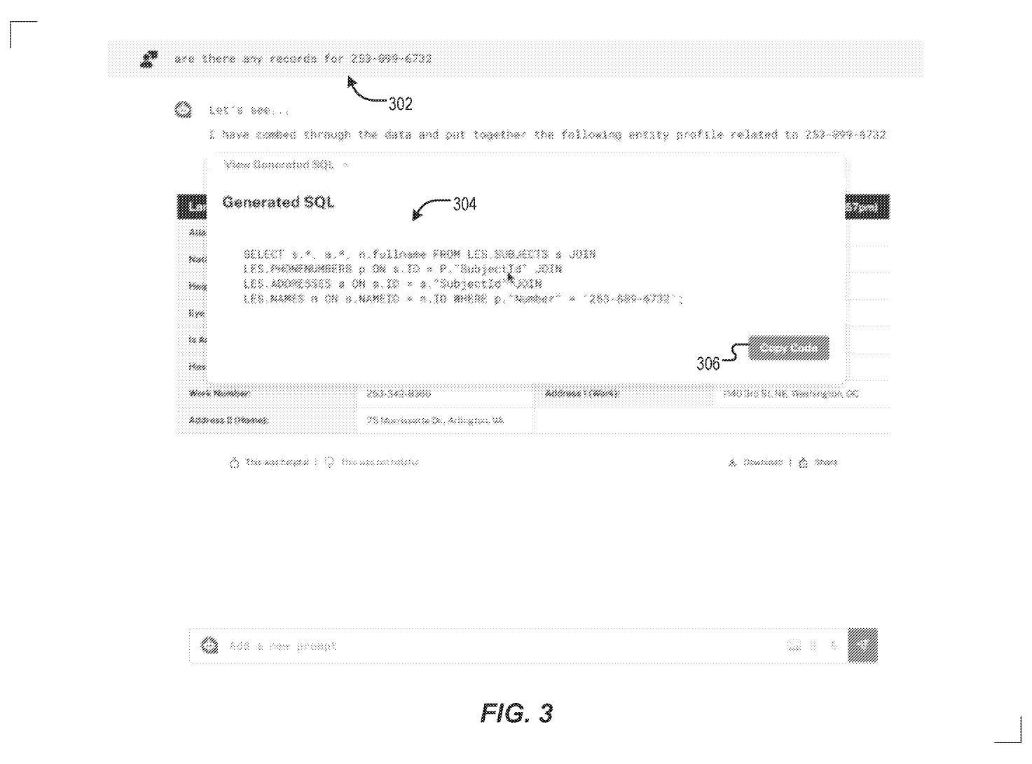

FIG. 3 illustrates an example interaction between a user and the AI engine 104 of FIG. 1. In particular, FIG. 3 illustrates a text-to-query interaction that demonstrates how the system of FIG. 1 processes natural language inputs and converts them into structured database queries. The interaction of FIG. 3 begins with a user query 302, shown at the top of the user interface 102. The user query 302 is a natural language input with a request for information about records associated with a specific phone number. The AI engine 104 can process the user query 302 to determine the intent of the query 302 and to determine what information to retrieve from underlying databases. In some examples, the user query 302 is enhanced by the RAG module 106 with additional context before being processed by the responder LLMs 202 to generate appropriate database queries.

In response to the user query 302, the system generates and returns SQL code 304 that represents the structured database query created by the system in response to the natural language input. The generated SQL code 304 demonstrates how the system translates the user's unstructured request into a structured database query that joins multiple tables across databases to produce complete entity profiles. In some examples, the generated SQL code 304 includes JOIN operations that connect information from subjects, phone numbers, addresses, and names tables to retrieve comprehensive information about individuals, objects, records, etc. The AI engine 104 may coordinate with the responder LLMs 202 to construct the SQL code 304 using chain-of-thought prompting techniques that break down the query generation process into logical steps, allowing the system to reason through the relationships between different data tables and construct appropriate JOIN clauses.

As shown in FIG. 3, the interface includes a button 306 that allows the user to copy and easily transfer the SQL code 304 to other applications or systems. The user interface 102 can include additional or alternative user interface elements that enhance user interaction with the system output. The AI engine 104 can use in-context learning techniques when generating the SQL code 304, e.g., by incorporating examples of similar queries from the RAG module 106 to improve the accuracy and structure of the generated SQL code 304 and to ensure the output follows proper database query syntax and includes appropriate table relationships for retrieving the requested information.

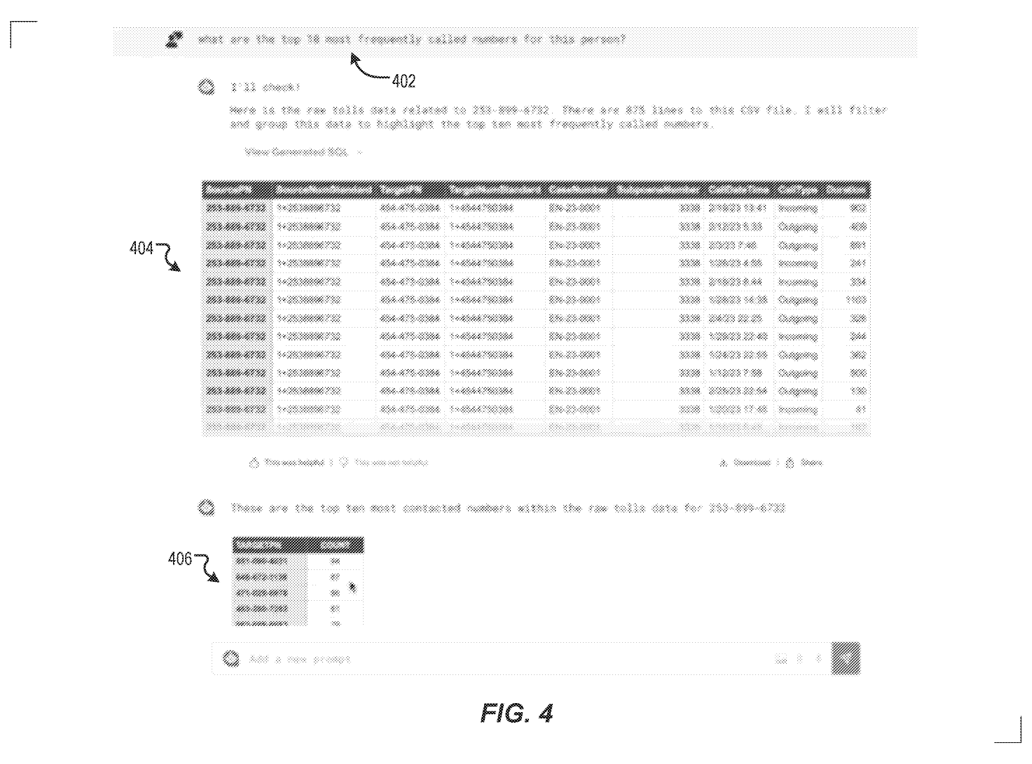

FIG. 4 illustrates another example interaction within the user interface 102 of FIG. 1. In particular, FIG. 4 illustrates a query processing workflow that demonstrates how the system of FIG. 1 handles database query results and transforms raw information into organized, user-friendly results. As shown in FIG. 4, the workflow begins with a user query 402 that requests specific information about frequently called numbers associated with a particular phone number. The user query 402 represents a natural language input that the AI engine 104 processes to understand the user's intent and determine the appropriate database operations to retrieve the requested information. In some implementations, the AI engine 104 enhances the user query 402 with contextual information from the RAG module 106 before coordinating with the responder LLMs 202 to generate the appropriate database queries and process the resulting data.

The system retrieves and displays raw tabular data 404 resulting from the database query execution. The raw tabular data 404 includes multiple rows of call records with columns showing source numbers, timestamps, destination numbers, call durations, and other call-related metadata stored in the underlying database tables. In some cases, the raw tabular data 404 represents the direct output from complex SQL queries that join multiple database tables to gather comprehensive information about phone call patterns, object relationships, user records, etc. The AI engine 104 may coordinate with the responder LLMs 202 to process and analyze the raw tabular data 404, applying natural language processing (NLP) techniques to extract meaningful patterns and relationships from the structured data.

As shown in FIG. 4, the system can transform the raw tabular data 404 into an output table 406 that presents summarized information in a more accessible and organized format. The output table 406 includes a condensed view of the most contacted numbers, along with their respective call counts, providing the user with a clear summary of the communication patterns identified in the raw tabular data 404. The transformation from raw tabular data 404 to the output table 406 demonstrates how the AI engine 104 uses multiple LLMs for different purposes. For example, the responder LLMs 202 process the data, the evaluator LLM 204 assesses the accuracy of the analysis, and the reporter LLM 208 formats the results for user presentation. The ensemble learning approach described herein allows the system to apply different analytical perspectives to the same dataset, with each model contributing specialized processing capabilities to ensure the output table 406 accurately represents the underlying data patterns.

In some implementations, multiple responder LLMs 202 analyze the raw tabular data 404 independently, allowing the evaluator LLM 204 to compare results and identify potential inconsistencies or errors in the data processing. Consistent transformation of raw tabular data 404 into structured output tables 406 helps maintain data integrity and accuracy across different query types and data volumes. The system can handle varying amounts of raw tabular data 404, from small datasets with few records to large datasets containing thousands of call records, while maintaining consistent processing performance and output quality. The reporter LLM 208 can provide explanations of how the raw tabular data 404 was processed and transformed into the final output table 406, allowing users to understand the analytical steps and verify the accuracy of the results.

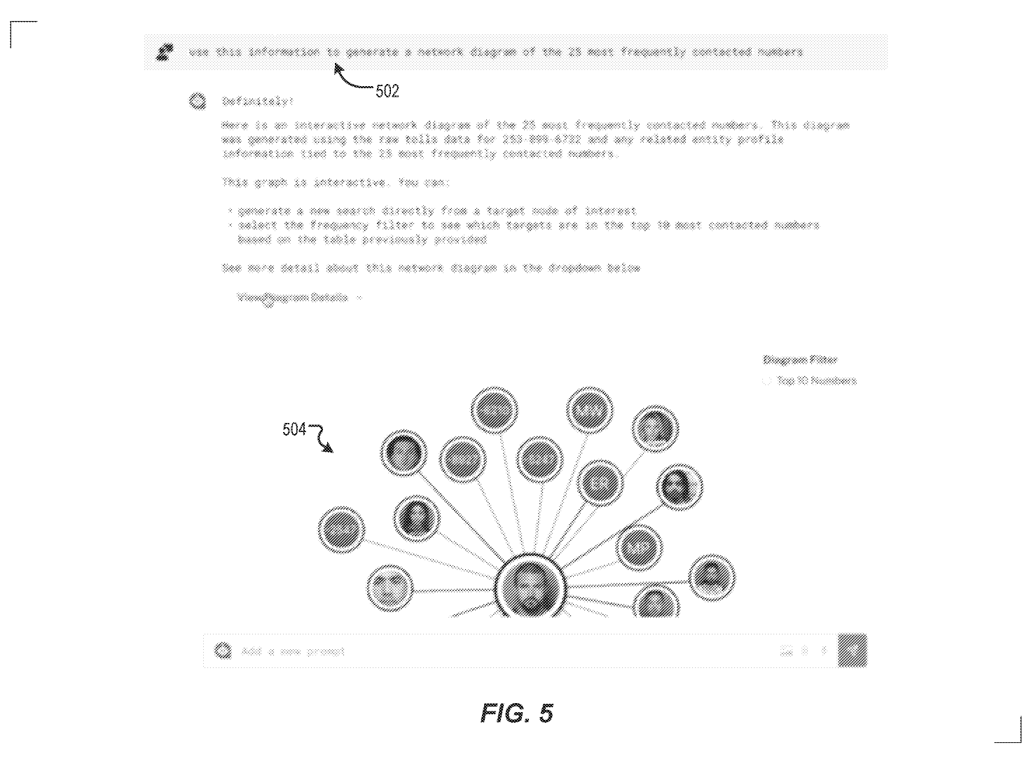

FIG. 5 illustrates another example interaction within the user interface 102. The interaction shown in FIG. 5 demonstrates the capability of the system to generate visual representations of entity relationships. As shown in FIG. 5, the interaction begins with a user query 502 that requests generation of a network diagram to visualize connections between entities identified in a previous analysis. The user query 502 represents a natural language request that the AI engine 104 processes to understand the user's intent and to generate relationship visualizations. In some cases, the AI engine 104 enhances the user query 502 with contextual information from the RAG module 106, such as templates or examples of network diagram structures that help guide the visualization generation process. The responder LLMs 202 may process the user query 502 to determine the appropriate data relationships and structural elements for generating meaningful visual representations of entity connections.

The system can generate and display a network diagram 504 in response to the user query 502, presenting entity relationships in an intuitive format that facilitates pattern recognition and analysis. The network diagram 504 includes a central node positioned at the center of the visualization, with multiple peripheral nodes arranged around the central node and connected through relationship lines that indicate associations between entities. In some implementations, connections extend outward from the central node to surrounding nodes, creating a visual hierarchy that emphasizes the central entity's role in the relationship network. The radial structure of the network diagram 504 allows users to quickly identify connection patterns, relationship densities, and potential clusters of related entities within the dataset. The AI engine 104 may coordinate with multiple responder LLMs 202 to analyze the underlying data and determine the most appropriate positioning and connection patterns for the entities displayed in the network diagram 504.

The network diagram 504 may can include identifying information within each node, allowing the user to understand what entities are represented and how the entities relate to one another within the broader network structure. The connections between nodes in the network diagram 504 represent relationships or interactions between the entities, with the visual representation helping users identify patterns that may not be apparent in tabular or text-based data presentations. In some cases, the evaluator LLM 204 assesses confidence levels by measuring agreement among ensemble responses from the multiple responder LLMs 202 when determining node placement, connection strength, and relationship significance within the network diagram 504. The evaluator LLM 204 may compare different approaches to network layout and entity relationship mapping generated by different responder LLMs 202, ensuring that the final network diagram 504 accurately represents the underlying data relationships. The reporter LLM 208 may generate explanations of how the network diagram 504 was constructed, including details about the algorithms used for node positioning, the criteria for establishing connections between entities, and the confidence levels associated with different relationship mappings displayed in the visualization.

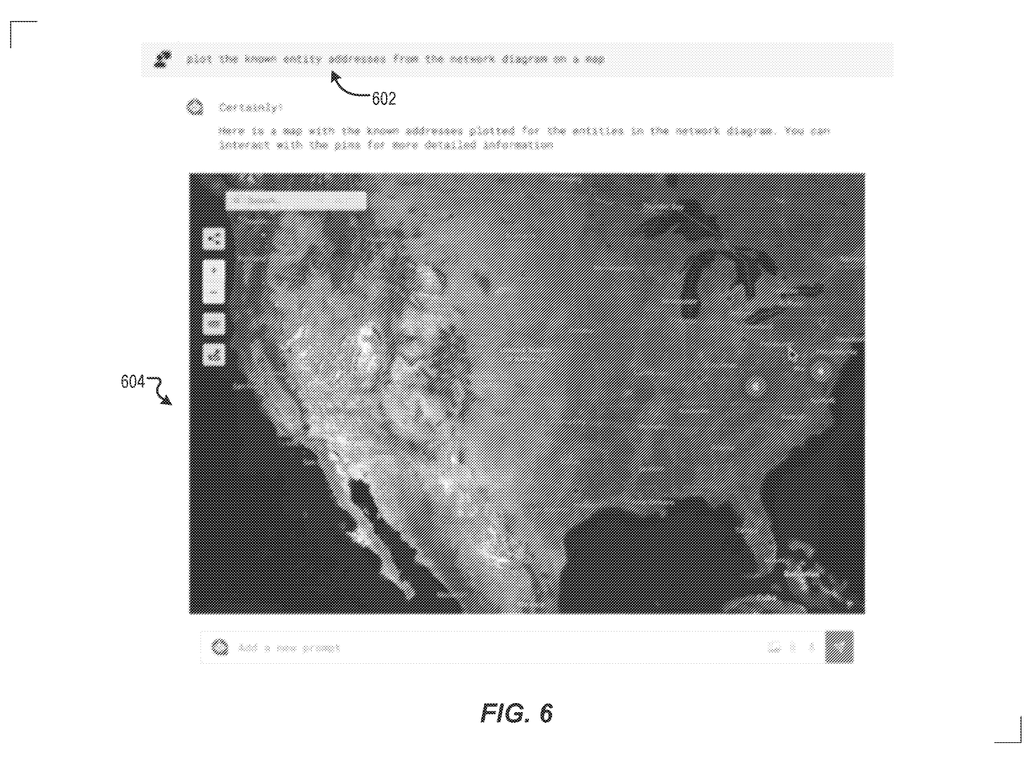

FIG. 6 illustrates another example interaction within the user interface 102. The interaction shown in FIG. 6 demonstrates geographic mapping capabilities of the system. As shown in FIG. 6, the interaction begins with a user query 602 that includes a request to plot known entity addresses from a network diagram onto a geographical map interface. The AI engine 104 may process the user query 602 to determine the user's intent for geographic visualization of entity locations. In some implementations, the AI engine 104 enhances the user query 602 with contextual information from the RAG module 106, such as geographic data templates or mapping configuration parameters that guide the visualization generation process. The responder LLMs 202 can process the user query 602 to extract location information from previously analyzed data and determine the appropriate geographic coordinates for mapping entity positions.

The system can generate and display an interactive map 604 in response to the user query 602, presenting entity locations within a geographical context that allows the user to analyze spatial relationships and geographic patterns. The interactive map 604 includes a geographical view that displays various locations marked with indicators, pins, or other visual elements representing the positions of entities identified in the underlying data analysis. In some implementations, the interactive map 604 provides navigation controls that allow users to pan, zoom, and explore different geographic regions and/or to examine entity distributions across various scales and locations. The AI engine 104 may coordinate with multiple responder LLMs 202 to process address information, geocode location data, and determine appropriate map positioning for the entities displayed on the interactive map 604. The responder LLMs 202 can analyze address formats, resolve geographic ambiguities, and standardize location data to ensure accurate positioning of entities on the interactive map 604.

The interactive map 604 may allow the user to interact with plotted data points and/or to access detailed information about specific entities or locations represented on the map. In some cases, the user may select individual markers or pins on the interactive map 604 to view additional details about the entities located at those positions, such as contact information, relationship data, or other attributes associated with the mapped entities. The evaluator LLM 204 can assess the accuracy of geographic positioning by comparing location data processed by different responder LLMs 202, e.g., to ensure that entity positions on the interactive map 604 accurately reflect the underlying address information and geographic relationships. The reporter LLM 208 can generate summaries and alerts in user-desired detail and format based on evaluation results from the geographic mapping process, providing users with confidence assessments about the accuracy of plotted locations and highlighting any potential discrepancies or uncertainties in the geographic data.

The interactive map 604 may support different map views, layers, and display options that allow the user to customize the geographic visualization according to their analytical preferences. In some implementations, the interactive map 604 includes satellite imagery, street maps, topographic views, or other geographic base layers that provide different perspectives on the spatial relationships between mapped entities. The system can be customized for different application domains including law enforcement, medicine, legal advocacy, government, and scientific research by adjusting the types of geographic data displayed, the mapping symbology used, and/or the interactive features available within the interactive map 604. The AI engine 104 may coordinate with the RAG module 106 to incorporate domain-specific geographic information, such as jurisdictional boundaries for law enforcement applications or facility locations for medical research contexts, enhancing the relevance and utility of the interactive map 604 for specific use cases.

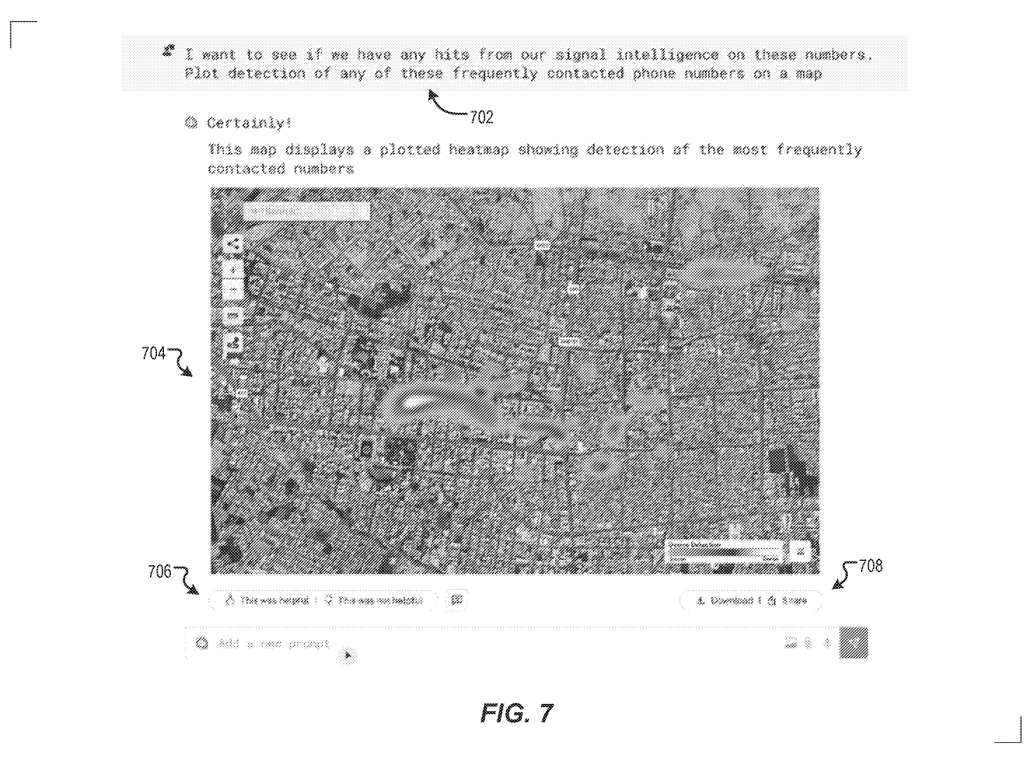

FIG. 7 illustrates another example interaction within the user interface 102. The interaction shown in FIG. 7 demonstrates heat map visualization capabilities of the system . As shown in FIG. 7, the interaction begins with a user query 702 that requests the system to plot detection of frequently contacted phone numbers on a geographical map using intensity-based visualization techniques. The AI engine 104 can process the user query 702 to understand the intent of the user query 702, e.g., to create a heat map visualization that represents communication frequency patterns across geographic regions. In some implementations, the AI engine 104 enhances the user query 702 with contextual information from the RAG module 106, such as geographic analysis templates or heat map configuration parameters that guide the visualization generation process. The responder LLMs 202 can process the user query 702 to analyze communication frequency data and determine appropriate intensity mapping algorithms for representing contact patterns across different geographic locations.

The system can generate and display a heat map 704 in response to the user query 702, presenting geographical areas with varying color intensities to indicate contact frequency patterns and communication density distributions. The heat map 704 includes different intensity levels represented through color gradients or shading variations, where areas with higher communication frequencies appear with greater intensity compared to regions with lower contact activity. In some examples, the heat map 704 overlays intensity data onto geographical base maps, allowing the user to correlate communication patterns with specific geographic features, population centers, and/or administrative boundaries. The AI engine 104 may coordinate with multiple responder LLMs 202 to process location data, calculate frequency distributions, and generate appropriate intensity mappings for the heat map 704 visualization. The responder LLMs 202 can analyze communication metadata, aggregate frequency counts by geographic regions, and apply statistical algorithms to normalize intensity values across different areas represented in the heat map 704.

The evaluator LLM 204 may assess the accuracy of heat map generation by comparing frequency calculations and intensity mappings produced by different responder LLMs 202, ensuring that the heat map 704 accurately represents the underlying communication patterns and geographic distributions. In some implementations, the evaluator LLM 204 measures agreement or cohesion among ensemble responses from the multiple responder LLMs 202 when determining intensity thresholds, color mapping algorithms, and/or geographic aggregation methods used in the heat map 704 visualization. The evaluator LLM 204 can identify potential inconsistencies in frequency calculations or geographic positioning that may affect the accuracy of the intensity patterns displayed in the heat map 704. The system can use both passive observability through logging of heat map generation processes and active alert mechanisms for high-priority events such as detection of unusual communication patterns or potential data anomalies in the frequency distributions.

As shown in FIG. 7, the system includes a feedback interface 706 positioned below the heat map 704. The feedback interface 706 allows the user to indicate whether the system response (e.g., the heat map 704) is helpful or not. This feedback can be used to improve the quality, accuracy, or reliability of subsequent outputs generated by the system. In some examples, the feedback interface 706 allows the user to request modifications to the visualization or access additional analytical functions related to the displayed frequency patterns. In some implementations, the feedback interface 706 includes controls for adjusting intensity thresholds, modifying color schemes, or changing the geographic resolution of the heat map 704 display. The reporter LLM 208 can process user feedback received through the feedback interface 706 to generate summaries and alerts in user-desired detail and format based on the heat map analysis results and user interaction patterns.

As shown in FIG. 7, the user interface 102 may include buttons 708 that allow the user to download or share the heat map 704 with other users or systems. In some implementations, the heat map 704 can be exported in different file formats, such as image files for presentation purposes or data files for further analysis in external applications. In some implementations, the heat map 704 can be shared through various communication channels, such as email, messaging systems, or collaborative platforms used within organizational workflows. The AI engine 104 may coordinate with the reporter LLM 208 to generate accompanying documentation or metadata that explains the heat map 704 generation process, data sources, and/or analytical parameters. This information can be distributed, downloaded, or shared along with the heat map 704. The adversary LLM 206 can generate poisoned data or manipulated prompts for testing and strengthening the other LLMs against adversarial attacks that may attempt to compromise the accuracy of heat map visualizations or introduce false patterns into the frequency analysis results.

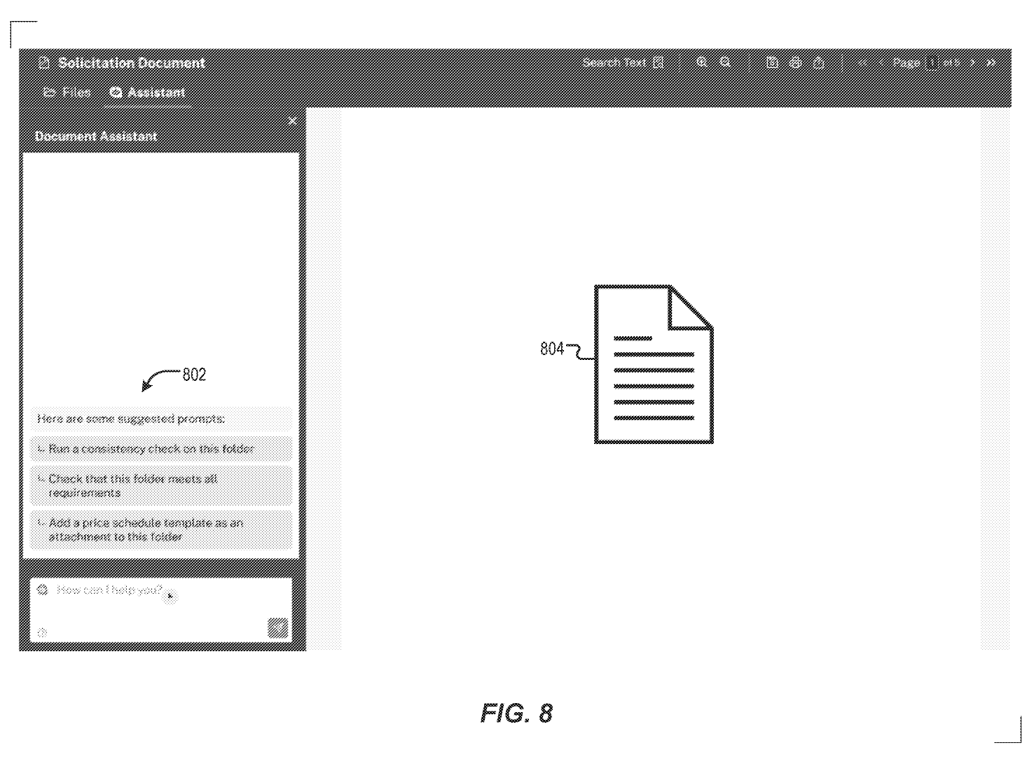

FIG. 8 illustrates another example interaction within the user interface 102. The interaction depicted in FIG. 8 shows how users can interact with documents through automated prompt suggestions and management capabilities of the system. As shown in FIG. 8, the interface displays suggested prompts 802 positioned in a panel on the left side of the user interface 102. The suggested prompts 802 include various options for document processing operations, such as running consistency checks across multiple documents and adding templates to streamline document creation workflows. In some implementations, the AI engine 104 coordinates with the RAG module 106 to generate the suggested prompts 802 based on the type of document being processed and/or previous interaction patterns of the user. The RAG module 106 may organize information into separate repositories that include sample documents for acquisition processes and prompts for common user questions, allowing the system to provide contextually appropriate suggestions for document management tasks.

In FIG. 8, a document 804 is displayed in the main viewing area on the right side of the user interface 102. In some examples, the document 804 is an acquisition document, contract, reports, or other text-based file that users can process or analyze within the system. In some cases, the AI engine 104 processes the content of the document 804 to determine appropriate suggested prompts 802 that align with the document type, content structure, or processing operations associated with the specific document. The responder LLMs 202 can analyze the document 804 to identify patterns, formatting structures, and/or content elements that allow the system to generate contextually relevant suggested prompts 802 for document management and processing tasks.

The user interface 102 allows the user to select prompts 802 that can be applied to or used with the displayed document 804 for various processing operations. For example, the user can select (e.g., click) one of the suggested prompts 802 to trigger automated document analysis, consistency checking, template application, or other document management functions that the AI engine 104 coordinates through the responder LLMs 202. The evaluator LLM 204 may assess the suitability of the prompts 802 by analyzing the content of the document 804 and comparing recommendations generated by different responder LLMs 202 to ensure the suggested prompts 802 align with the document type and user preferences. The system architecture follows a modular open system approach that uses Docker containers for portability and scalability, allowing document assistance functionality to be deployed across different computing environments while maintaining consistent performance and feature availability.

The reporter LLM 208 may generate summaries and alerts in user-desired detail and format based on the results of document processing operations initiated through the suggested prompts 802, providing users with feedback about the completion status, identified issues, or recommendations for further document management actions. In some examples, the suggested prompts 802 include options for compliance checking, document comparison, template insertion, formatting standardization, or content validation that leverage ensemble learning capabilities of the responder LLMs 202 to provide comprehensive document analysis and management support. The RAG module 106 can maintain repositories of document templates, formatting guidelines, and processing workflows that inform generation of suggested prompts 802 and enhance the contextual relevance of document assistance recommendations provided through the user interface 102. The adversary LLM 206 can generate poisoned data or manipulated prompts to test and strengthen the document processing capabilities against potential attacks that could compromise document integrity or introduce false information into document management workflows.

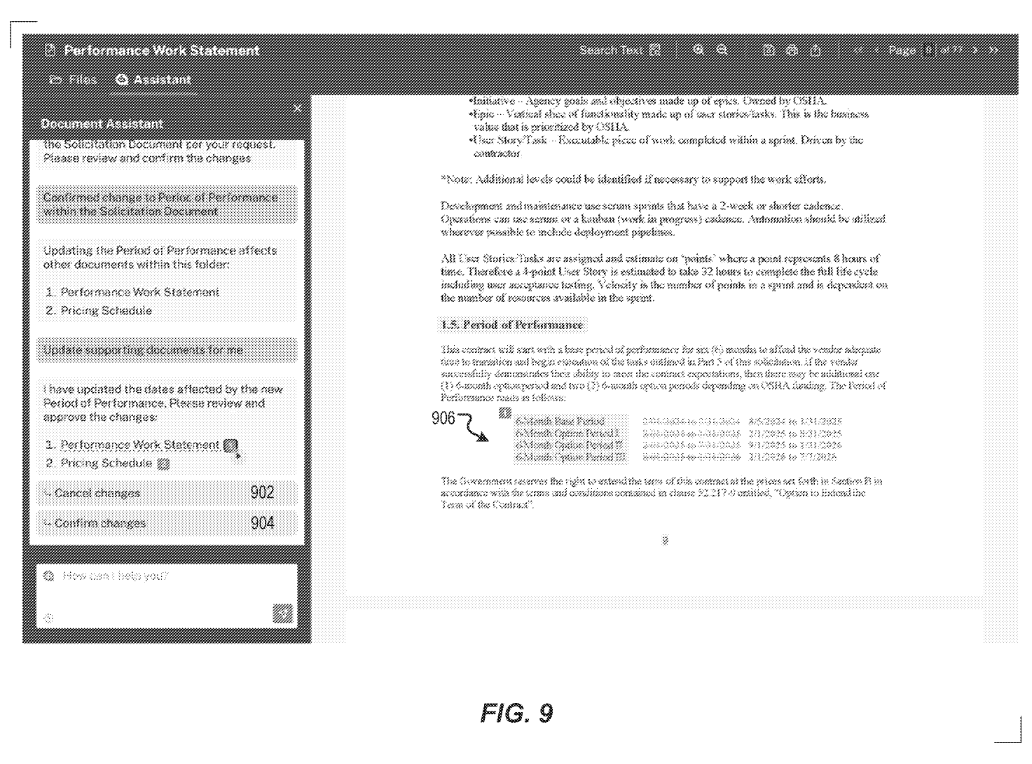

FIG. 9 illustrates another example interaction within the user interface 102. The interaction shown in FIG. 9 demonstrates document change management capabilities of the system. For example, the user interface 102 allows users to handle pending document modifications through a structured workflow . As shown in FIG. 9, the system presents pending changes 906 that require user action to maintain document consistency and integrity across related files. The pending changes 906 represent modifications that have been made by the AI engine 104 within the same project or document set. In some implementations, the AI engine 104 coordinates with the responder LLMs 202 to analyze document relationships and identify potential inconsistencies that arise when modifications are made to individual documents without corresponding updates to related files. The system can automatically identify and suggest updates to related documents when changes are made to one document, helping to maintain consistency across document collections and preventing discrepancies that could affect document accuracy or compliance.

The user interface 102 includes an option 902 to cancel the pending changes 906, providing a mechanism to reject or reverse proposed modifications without affecting the current document state. The user can select option 902 when the user determines that the proposed changes are not appropriate for the current context. In some cases, selecting the option 902 maintains the existing document state and prevents any modifications from being applied to the current document or related files. The AI engine 104 may coordinate with the evaluator LLM 204 to assess the implications of canceling the pending changes 906, providing the user with information about potential consequences or alternative approaches for addressing document consistency issues. The system can implement compliance checks by generating checklists tailored to specific acquisition types, allowing the evaluator LLM 204 to determine whether canceling the pending changes 906 will affect compliance with regulatory standards or organizational policies.

The user interface 102 also includes an option 904 to confirm the pending changes 906, allowing the user to approve and implement the proposed modifications across the specified documents. The user may select option 904 when the user has reviewed the proposed changes and determined that the modifications are appropriate for maintaining document consistency and accuracy. In some implementations, selecting the option 904 triggers the AI engine 104 to coordinate with the responder LLMs 202 to apply the approved changes to the relevant documents while maintaining proper formatting, structure, and content relationships. The reporter LLM 208 can generate summaries and alerts in user-desired detail/format based on the change implementation process, providing the user with confirmation of completed modifications and documentation of the changes that were applied to each affected document. The system can track change history and maintain audit trails, e.g., to document the pending changes 906 and whether the user selected option 902 or option 904.

The RAG module 106 can enhance the document change management process by providing contextual information about document templates, formatting standards, and regulatory constraints associated with the pending changes 906 and the generation of appropriate modification recommendations. In some examples, the RAG module 106 organizes information into separate repositories that include sample documents for acquisition processes and prompts for common user questions, which allows the system to apply domain-specific knowledge when analyzing document relationships and proposing changes to maintain consistency. The adversary LLM 206 can generate poisoned data or manipulated prompts for testing and strengthening the document change management capabilities against potential attacks that could compromise document integrity or introduce unauthorized modifications into document workflows.

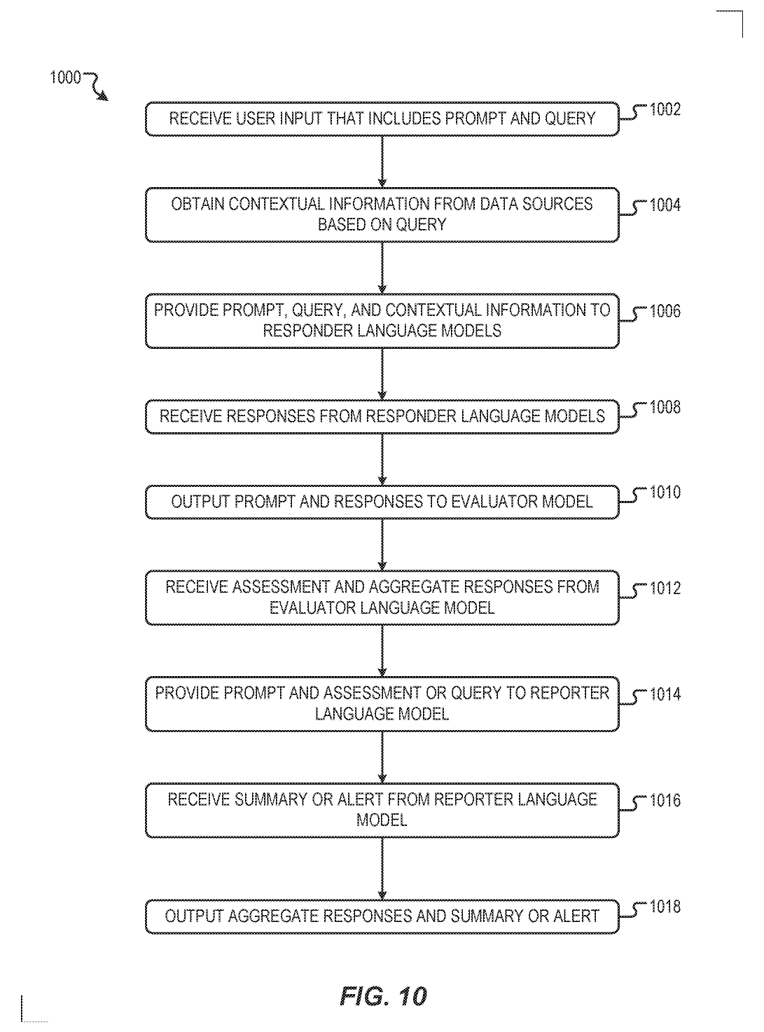

FIG. 10 is a flowchart of an example method 1000 for LLM evaluation and enhancement, according to some implementations. For clarity of presentation, the method 1000 is described in the context of the preceding figures. For example, the method 1000 can be performed by the AI engine 104 of FIG. 1, or by any suitable system, environment, software, hardware, or combination thereof. The operations of the method 1000 can be performed in parallel, in combination, in loops, or in any order. The example method 1000 shown in FIG. 10 can be modified or reconfigured to include additional, fewer, or different steps (not shown in FIG. 10), which can be performed in the order shown or in a different order.

At 1002, the AI engine 104 receives a user input that includes a prompt and a query. The AI engine 104 may receive the user input through the user interface 102. The user input may represent a natural language request for information, analysis, or processing. In some implementations, the prompt provides context or instructions for how to process the query, and the query includes the specific information request or task that the user wants the system to perform. The AI engine 104 can parse and analyze the user input to determine the intent, complexity, and domain-specific aspects of the request.

At 1004, the AI engine 104 obtains contextual information from one or more data sources based on the query. The AI engine 104 may coordinate with the RAG module 106 to search through relevant repositories and knowledge sources to enhance the context of the user query. In some cases, the RAG module 106 performs semantic searches within vector databases to retrieve document embeddings and other contextually appropriate information that can improve the accuracy and relevance of subsequent processing steps. The contextual information may include domain-specific documents, templates, examples, or reference materials that are relevant to the user query.

At 1006, the AI engine 104 provides the prompt, the query, and the contextual information to multiple responder language models, such as the responder LLMs 202 of FIG. 2. The AI engine 104 may select specific responder models based on the characteristics of the query, the domain of the request, or the type of processing involved. In some implementations, the AI engine 104 distributes the enhanced query information to multiple responder models simultaneously to enable parallel processing and generate diverse perspectives on the same input. The responder language models can process the combined information using different approaches or specialized capabilities to generate comprehensive responses.

At 1008, the AI engine 104 receives multiple responses from the responder language models. Each responder model may generate a different response, providing various perspectives and solutions to the user's query. In some examples, the responses include different interpretations of the query, alternative approaches to solving the problem, or varying levels of detail and specificity.

At 1010, the AI engine 104 outputs the prompt and the responses from the responder language models to an evaluator language model, such as the evaluator LLM 204, that is configured to perform an assessment or analysis of the responses. The evaluator language model can analyze the consistency, accuracy, and/or quality of the responses generated by the different responder language models. In some implementations, the evaluator language model compares the different responses to identify areas of agreement or disagreement, potential inconsistencies, and relative confidence levels associated with different aspects of the generated outputs. The evaluation process may involve analyzing both the content and reasoning provided by each responder model. In some examples, the evaluator language model is trained using an adversary language model, such as the adversary LLM 206, that provides flawed or inconsistent data to the evaluator language model.

At 1012, the AI engine 104 receives the assessment and one or more aggregate responses provided by the evaluator language model. In some implementations, the evaluator language model combines information from the multiple responses into a consolidated output that represents the most accurate and reliable elements from the ensemble of responses provided by the responder language models. The assessment may include confidence scores, quality metrics, and/or explanations of how the aggregate responses were derived from the original inputs. The evaluator language model can also identify potential hallucinations, inconsistencies, or areas where the responder language models provided conflicting information.

At 1014, the AI engine 104 provides the prompt and at least one of the assessment or the query to a reporter language model, such as the reporter LLM 208, that is configured to generate an alert or summary based on the aggregate responses. The reporter language model can process the evaluation results to create user-friendly reports that explain the confidence levels, highlight areas of agreement or disagreement among the responder language models, and provide transparency about the decision-making process. In some implementations, the reporter language model generates different types of outputs depending on the user's preferences and the context of the query.

At 1016, the AI engine 104 receives the summary or alert from the reporter language model. The reporter language model can generate summaries and alerts in user-desired detail and format based on the evaluation results, providing users with clear explanations of how the responses were generated and what confidence levels are associated with the outputs. In some implementations, the summary includes recommendations for further actions, warnings about potential issues, or explanations of the analytical processes that were used to generate the final results.

At 1018, the AI engine 104 outputs the aggregate responses and the summary or alert for display on the user interface 102. The user interface 102 may present the final results along with explanatory information, confidence indicators, and interactive elements that allow the user to explore the details of the analysis. In some implementations, the output may include visualizations, structured data, database queries, or other formats suitable for the user's request and the type of information being presented. The system may provide options for the user to download, share, or further process the generated results.

Implementations and all of the functional operations and/or actions described in this specification can be implemented in digital electronic circuitry, or in computer software, firmware, or hardware, including the structures disclosed in this specification and their structural equivalents, or in combinations of one or more of them. Implementations may be implemented as one or more computer program products, e.g., one or more modules of computer program instructions encoded on a computer readable medium for execution by, or to control the operation of, a data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor can receive instructions and data from ROM, RAM, or both.

Elements of a computer may include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer may not have such devices. Moreover, a computer may be embedded in another device, e.g., a tablet computer, a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT), liquid crystal display (LCD), or light emitting diode (LED) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Implementations may be implemented in a computing system that includes a back end component, e.g., as a data server, or that includes a middleware component, e.g., an application server, or that includes a front end component, e.g., a client computer having the graphical user interface or a Web browser through which a user may interact with an implementation, or any combination of one or more such back end, middleware, or front end components. The components of the system may be interconnected by any form or medium of digital data communication, e.g., a communication network.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Some features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in some combinations and even initially claimed as such, one or more features from a claimed combination may in some cases be excised from the combination, and the claimed combination may be directed to a sub-combination or variation of a sub-combination.

Similarly, while actions are depicted in the drawings in a particular order, this should not be understood as requiring that such actions be performed in the particular order shown or in sequential order, or that all illustrated actions be performed, to achieve desirable results. Moreover, the separation of various system components in the implementations described above should not be understood as requiring such separation in all implementations, and it should be understood that the described program components and systems may generally be integrated together in a single software product or packaged into multiple software products.

In the preceding description, various components are described as performing a task or tasks. Such descriptions should be interpreted as including the phrase “configured to.” Reciting a component that is configured to perform one or more tasks is expressly intended not to invoke 35 U.S.C. § 112(f) interpretation for that component.

A number of implementations have been described. Nevertheless, it is understood that various modifications can be made without departing from the spirit and scope of the present disclosure. Accordingly, other implementations are within the scope of the following claims.

1. A method comprising:
receiving a user input comprising a prompt and a query;
obtaining contextual information from one or more data sources based on the query;
providing the prompt, the query, and the contextual information to a plurality of responder language models;
receiving a plurality of responses from the plurality of responder language models;
outputting the prompt and the plurality of responses to an evaluator language model that is configured to perform an assessment of the plurality of responses;
receiving the assessment and one or more aggregate responses from the evaluator language model;
providing the prompt and at least one of the assessment or the query to a reporter language model that is configured to generate an alert or summary of the one or more aggregate responses;
receiving the summary or alert from the reporter language model; and
outputting the one or more aggregate responses and the summary or alert for display on a user interface.

2. The method of claim 1, wherein the evaluator language model is trained using a generative adversarial network (GAN) framework in which the evaluator language model iteratively competes with an adversary language model that is configured to provide inconsistent or incorrect data to the evaluator language model.

3. The method of claim 1, wherein the assessment indicates at least one of:
a confidence score indicating a degree of similarity between the plurality of responses received from the plurality of responder language models;
one or more inconsistencies between the plurality of responses received from the plurality of responder language models; or
a quality metric indicating an accuracy of the plurality of responses.

4. The method of claim 1, wherein the evaluator language model is configured to combine information from the plurality of responses into the one or more aggregate responses.

5. The method of claim 1, wherein the summary or alert comprises at least one of:
an explanation of how the one or more aggregate responses were generated from the plurality of responses;
a confidence level associated with the one or more aggregate responses; or
an indication of possible inconsistencies in the one or more aggregate responses.

6. The method of claim 1, wherein the reporter language model is configured to monitor and report performance metrics for the plurality of responder language models, the evaluator language model, and the reporter language model.

7. The method of claim 1, further comprising:
receiving, via the user interface, feedback regarding the one or more aggregate responses; and
adjusting parameters of at least one of the evaluator language model, the reporter language model, or the plurality of responder language models based on the feedback.

8. The method of claim 1, wherein the one or more aggregate responses comprise at least one of:
a heat map comprising a visualization of geographic intensity patterns;
an interactive network diagram indicating relationships between a plurality of entities;
structured tabular data;
a database query command; or
an interactive map that indicates respective locations of the plurality of entities.

9. The method of claim 1, further comprising:
identifying one or more pending changes to a first document based on previous changes to a second document;
receiving, via the user interface, a request to confirm or cancel the pending changes to the first document; and
applying the pending changes to the first document in accordance with the request.

10. The method of claim 1, wherein obtaining contextual information comprises:
performing a semantic search within a vector database to one or more document embeddings; and
providing the one or more document embeddings to the plurality of responder language models with the query and the prompt.

11. The method of claim 1, further comprising:
determining a maturity level of each responder language model based on at least one of an accuracy metric, a consistency metric, or a transparency metric associated with the responder language model; and
selecting a subset of the plurality of responder language models to process the query based on the determined maturity level.

12. The method of claim 11, wherein the accuracy metric comprises a percentage of correct responses generated by the responder language model, the consistency metric comprises a stability score indicating variability in responses provided by the responder language model, and the transparency metric indicates a traceability of responses provided by the responder languagemodel.

13. The method of claim 1, wherein the one or more data sources comprise repositories of domain-specific information, the repositories comprising at least one of:
legal databases comprising case law and regulatory documents;
medical databases comprising patient records and clinical guidelines;
law enforcement databases comprising criminal records and investigative data; or
government databases comprising policy documents and procedural guidelines.

14. The method of claim 13, wherein obtaining the contextual information comprises:
identifying a domain associated with the query;
selecting one or more repositories from the repositories of domain-specific information that are associated with the identified domain; and
retrieving the contextual information from the selected repositories.

15. A system comprising:
one or more processors; and
memory storing instructions that, when executed by the one or more processors, cause the system to perform operations comprising:
receiving a user input comprising a prompt and a query;
obtaining contextual information from one or more data sources based on the query;
providing the prompt, the query, and the contextual information to a plurality of responder language models;
receiving a plurality of responses from the plurality of responder language models;
outputting the prompt and the plurality of responses to an evaluator language model that is configured to perform an assessment of the plurality of responses;
receiving the assessment and one or more aggregate responses from the evaluator language model;
providing the prompt and at least one of the assessment or the query to a reporter language model that is configured to generate an alert or summary of the one or more aggregate responses;
receiving the summary or alert from the reporter language model; and
outputting the one or more aggregate responses and the summary or alert for display on a user interface.

16. The system of claim 15, wherein the evaluator language model is trained using a GAN framework in which the evaluator language model iteratively competes with an adversary language model that is configured to provide inconsistent or incorrect data to the evaluator language model.

17. The system of claim 15, wherein the assessment indicates at least one of:
a confidence score indicating a degree of similarity between the plurality of responses received from the plurality of responder language models;
one or more inconsistencies between the plurality of responses received from the plurality of responder language models; or
a quality metric indicating an accuracy of the plurality of responses.

18. The system of claim 15, wherein the evaluator language model is configured to combine information from the plurality of responses into the one or more aggregate responses.

19. The system of claim 15, wherein the summary or alert comprises at least one of:
an explanation of how the one or more aggregate responses were generated from the plurality of responses;
a confidence level associated with the one or more aggregate responses; or
an indication of possible inconsistencies in the one or more aggregate responses.

20. A non-transitory computer-readable medium storing instructions that, when executed by one or more processors, cause the one or more processors to perform operations comprising:
receiving a user input comprising a prompt and a query;
obtaining contextual information from one or more data sources based on the query;
providing the prompt, the query, and the contextual information to a plurality of responder language models;
receiving a plurality of responses from the plurality of responder language models;
outputting the prompt and the plurality of responses to an evaluator language model that is configured to perform an assessment of the plurality of responses;
receiving the assessment and one or more aggregate responses from the evaluator language model;
providing the prompt and at least one of the assessment or the query to a reporter language model that is configured to generate an alert or summary of the one or more aggregate responses;
receiving the summary or alert from the reporter language model; and
outputting the one or more aggregate responses and the summary or alert for display on a user interface.
